(19) United States
(12) Patent Application Publication
(10) Pub. No.: US 2021/0242473 A1
(43) Pub. Date: Aug. 5, 2021

(54) JOINT SEPARATOR, METAL SEPARATOR, AND METHOD OF PRODUCING FUEL CELL STACK

(71) Applicant: HONDA MOTOR CO., LTD., TOKYO (JP)

(72) Inventors: Suguru OHMORI, WAKO-SHI (JP); Takuro OKUBO, WAKO-SHI (JP)

(21) Appl. No.: 17/160,795

(22) Filed: Jan. 28, 2021

(30) Foreign Application Priority Data
Jan. 30, 2020 (JP) 2020-013754

(51) Int. Cl. H01M 8/0232; H01M 8/0247; H01M 8/0273; H01M 8/026; H01M 8/248; H01M 8/0284

(52) U.S. Cl. CPC H01M 8/0232; H01M 8/0247; H01M 8/0284; H01M 8/026; H01M 8/248; H01M 8/0273

(57) ABSTRACT

A joint separator is formed by joining a first metal separator and a second metal separator together in the state where the first metal separator and the second metal separator are stacked together. A first metal bead of the first metal separator and a second metal bead of the second metal separator have the same bead width. The ratio of the bead width to the bead height is set to be within the range of not less than 2.25 and not more than 3.35, where the bead height is a distance between a protruding end of the first metal bead and a protruding end of the second metal bead.

### CROSS-REFERENCE TO RELATED APPLICATION

This application is based upon and claims the benefit of priority from Japanese Patent Application No. 2020-013754 filed on Jan. 30, 2020, the contents of which are incorporated herein by reference.

### BACKGROUND OF THE INVENTION

### Field of the Invention

The present invention relates to a joint separator, a metal separator, and a method of producing a fuel cell stack.

### Description of the Related Art

The fuel cell stack includes a stack body. In the state where membrane electrode assemblies (MEAs) each including an electrolyte membrane and electrodes provided on both sides of the electrolyte membrane and joint separators are stacked alternately in a stacking direction to form the stack body, a compression load in the stacking direction is applied to the stack body. The joint separator is formed by joining a first metal separator and a second metal separator together in the state where the first metal separator and the second metal separator are stacked together (e.g., see the specification of U.S. Patent Application Publication No. 2006/0054664).

A first metal bead for preventing leakage of fluid (reactant gases and a coolant) from a portion between the MEA and the first metal separator is formed in the first metal separator of the joint separator. The first metal bead extends in a line pattern. The first metal bead is formed integrally with the first metal separator, and protrudes in a direction away from the second metal separator. The first metal bead is deformed elastically by the compression load. A second metal bead for preventing leakage of fluid (reactant gases and a coolant) from a portion between the MEA and the second metal separator is formed in the second metal separator of the joint separator. The second metal bead extends in a line pattern. The second metal bead is formed integrally with the second metal separator, and protrudes in a direction away from the first metal separator.

The first metal bead and the second metal bead are disposed so as to be overlapped with each other as viewed in the separator thickness direction. The first metal bead and the second metal bead have the same bead width.

### SUMMARY OF THE INVENTION

In the above described conventional technique, there is no discussion regarding the ratio of the bead width to the bead height (bead dimension ratio) where the bead height is a distance between a protruding end of the first metal bead and a protruding end of the second metal bead in the state where no compression load is applied to the metal separator.

As the bead dimension ratio becomes small, the spring constant of bead side portions (a side portion of the first metal bead and a side portion of the second metal bead) becomes large. Under the circumstances, in the case where the spring constant of the bead side portions become excessively large, when the compression load is applied to the metal separator, the bead top portion may be buckled, and deformed in a recessed shape.

On the other hand, as the bead dimension ratio increases, the spring constant of the bead side portions become small. When the spring constant of the bead side portion becomes excessively small, when the compression load is applied to the metal separator, the desired seal surface pressure may not be applied to the bead top portion.

The present invention has been made taking such a problem into account, and an object of the present invention is to provide a joint separator, a metal separator, and a method of producing a fuel cell stack in which, when a compression load is applied to the metal separator, it is possible to apply the desired seal surface pressure to a bead top portion without buckling of the bead top portion.

According to a first aspect of the present invention, provided is a joint separator to be incorporated into a fuel cell stack, wherein: the joint separator is formed by joining a first metal separator and a second metal separator together in a state where the first metal separator and the second metal separator are stacked together, the joint separator being applied with a compression load in a separator thickness direction when the joint separator is incorporated in the fuel cell stack; a first metal bead as a seal is formed in the first metal separator, the first metal bead being elastically deformable by the compression load; the first metal bead extends in a line pattern, the first metal bead being formed integrally with the first metal separator and protruding in a direction away from the second metal separator; a second metal bead as a seal is formed in the second metal separator, the second metal bead being elastically deformable by the compression load; the second metal bead extends in a line pattern, the second metal bead being formed integrally with the second metal separator and protruding in a direction away from the first metal separator; the first metal bead and the second metal bead have a same bead width; and a ratio of the bead width to a bead height is set to be within a range of not less than 2.25 and not more than 3.35, where the bead height is a distance between a protruding end of the first metal bead and a protruding end of the second metal bead.

According to a second aspect of the present invention, provided is a metal separator to be incorporated into a fuel cell stack, wherein: the metal separator is applied with a compression load in a separator thickness direction when the metal separator is incorporated in the fuel cell stack; a metal bead as a seal is formed in the metal separator, the metal bead being elastically deformable by the compression load; the metal bead extends in a line pattern, the metal bead being formed integrally with the metal separator and protruding in the separator thickness direction; and a ratio of a bead width of the metal bead to a bead height is set to be within a range of not less than 4.5 and not more than 6.7, where the bead height is a protruding height of the metal bead.

According to a third aspect of the present invention, provided is a method of producing a fuel cell stack, the method including: a first preparing step of preparing a membrane electrode assembly including an electrolyte membrane and electrodes provided on both sides of the electrolyte membrane; a second preparing step of preparing a joint separator formed by joining a first metal separator and a second metal separator together in a state where the first metal separator and the second metal separator are stacked together; a stacking step of stacking the membrane electrode assembly and the joint separator together alternately; and a load applying step of, after the stacking step, applying a compression load in a separator thickness direction to the membrane electrode assembly and the joint separator, wherein: in the second preparing step, a first metal bead as a seal is formed in the first metal separator, the first metal bead being elastically deformable by the compression load, and a second metal bead as a seal is formed in the second metal separator, the second metal bead being elastically deformable by the compression load; the first metal bead extends in a line pattern, the first metal bead being formed integrally with the first metal separator and protruding in a direction away from the second metal separator; the second metal bead extends in a line pattern, the second metal bead being formed integrally with the second metal separator and protruding in a direction away from the first metal separator; the first metal bead and the second metal bead have a same bead width; and a ratio of the bead width to a bead height is set to be within a range of not less than 2.25 and not more than 3.35, where the bead height is a distance between a protruding end of the first metal bead and a protruding end of a second metal bead.

In the present invention, since the ratio of the bead width to the bead width (bead dimension ratio) is not less than 2.25 (the ratio of the bead width to the protruding height of the metal bead is not less than 4.5), the spring constant of the bead side portion does not become excessively large. Therefore, when the compression load is applied to the metal separator, it is possible to suppress buckling of the bead top portion. Further, since the bead dimension ratio is not more than 3.35 (since the ratio of the bead width to the protruding height of the metal bead is not more than 6.7), the spring constant of the bead side portion does not become excessive small. Therefore, when the compression load is applied to the metal separator, it is possible to apply the desired seal surface pressure to the bead top portion.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is an exploded perspective view showing a fuel cell stack according to an embodiment of the present invention;

FIG. 2 is a cross-sectional view taken along a line II-II in FIG. 1;

FIG. 3 is a plan view showing a first metal separator, as viewed from a side where a resin frame equipped MEA is present;

FIG. 4 is a plan view showing a second metal separator as viewed from a side where a resin frame equipped MEA is present;

FIG. 5 is a flow chart illustrating a method of producing the fuel cell stack in FIG. 1;

FIG. 6 is a partial cross-sectional view showing a joint separator where no compression load is applied to the joint separator;

FIG. 7A is a graph showing the relationship between the bead dimension ratio and the stress applied to a bead top portion;

FIG. 7B is a graph showing the relationship between the bead dimension ratio and the seal surface pressure; and

FIG. 8 is a graph showing a setting range of the bead height and the bead width.

DESCRIPTION OF THE PREFERRED EMBODIMENTS

Hereinafter, a preferred embodiment of a joint separator, a metal separator, and a method of producing a fuel cell stack will be described with reference to an accompanying drawings.

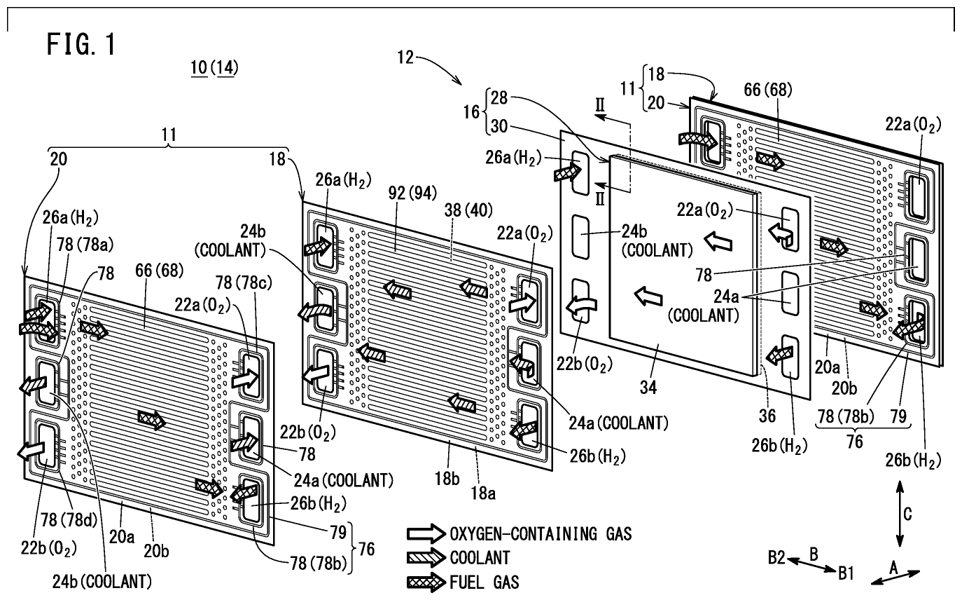

As shown in FIG. 1, a fuel cell stack 10 according to an embodiment of the present invention includes a stack body 14 formed by stacking a plurality of power generation cells 12. For example, the fuel cell stack 10 is mounted in a fuel cell automobile in a manner that the stacking direction of the plurality of power generation cells 12 (indicated by the arrow A) is oriented in the horizontal direction (the vehicle width direction or the vehicle length direction) of a fuel cell automobile. It should be noted that the fuel cell stack 10 may be mounted in the fuel cell automobile in a manner that the stacking direction of the plurality of power generation cells 12 is oriented in the vertical direction (vehicle height direction) of the fuel cell automobile.

The power generation cell 12 includes a resin frame equipped MEA 16, and a first metal separator 18 and a second metal separator 20 sandwiching the resin frame equipped MEA 16 in the direction indicated by an arrow A.

At one end of end of the power generation cells 12 in the long side direction indicated by an arrow B (end in the direction indicated by an arrow B1), an oxygen-containing gas supply passage 22a, a coolant supply passage 24a, and a fuel gas discharge passage 26b are arranged in the direction indicated by the arrow C. The oxygen-containing gas supply passage 22a extends through each of the power generation cells 12 in the stacking direction of the power generation cells 12 (direction indicated by the arrow A), for supplying the oxygen-containing gas. The coolant supply passage 24a extends through each of the power generation cells 12 in the direction indicated by the arrow A, for supplying a coolant (e.g., pure water, ethylene glycol, oil). The fuel gas discharge passage 26b extend through each of the power generation cells 12 in the direction indicated by the arrow A, for supplying a fuel gas (e.g., hydrogen containing gas).

At the other end of the power generation cells 12 in the direction indicated by the arrow B (end in a direction indicated by an arrow B2), a fuel gas supply passage 26a, a coolant discharge passage 24b, and an oxygen-containing gas discharge passage 22b are arranged in the direction indicated by an arrow C. The fuel gas supply passage 26a extends through each of the power generation cells 12 in the direction indicated by the arrow A, for supplying a coolant.

The coolant discharge passage 24b extends through each of the power generation cells 12 in the direction indicated by the arrow A, for discharging the coolant. The oxygen-containing gas discharge passage 22b extends through each of the power generation cells 12 in the direction indicated by the arrow A, for discharging the oxygen-containing gas.

The sizes, positions, shapes, and the numbers of the oxygen-containing gas supply passage 22a, the oxygen-containing gas discharge passage 22b, the fuel gas supply passage 26a, the fuel gas discharge passage 26b, the coolant supply passage 24a, and the coolant discharge passage 24b are not limited to the embodiment, and may be determined as necessary depending on the required specification.

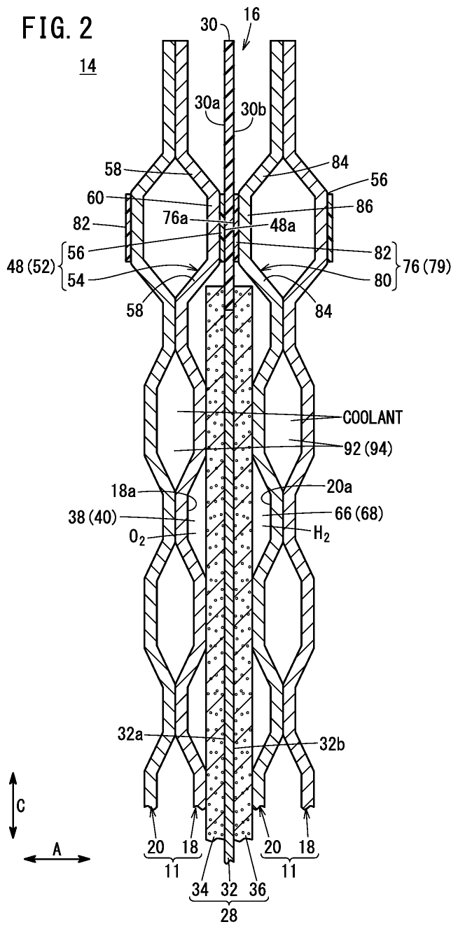

As shown in FIGS. 1 and 2, the resin frame equipped MEA 16 includes a membrane electrode assembly (hereinafter referred to as an “MEA 28”), and a resin frame member 30 (resin frame part, resin film) having a constant thickness. The resin frame member 30 is joined to an overlap part on an outer peripheral portion of the MEA 28, and provided around the outer peripheral portion of the MEA 28. In FIG. 2, the MEA 28 includes an electrolyte membrane 32, a cathode 34 provided on one surface 32a of the electrolyte membrane 32, and an anode 36 provided on the other surface 32b of the electrolyte membrane 32.

For example, the electrolyte membrane 32 is a solid polymer electrolyte membrane (cation ion exchange membrane). For example, the sold polymer electrolyte membrane is a thin membrane of perfluorosulfonic acid containing water. A fluorine based electrolyte may be used as the electrolyte membrane 32. Alternatively, an HC (hydrocarbon) based electrolyte may be used as the electrolyte membrane 32. The electrolyte membrane 32 is held between the cathode 34 and the anode 36.

Although not shown in details, the cathode 34 includes a first electrode catalyst layer joined to one surface 32a of the electrolyte membrane 32, and a first gas diffusion layer stacked on the first electrode catalyst layer. The first electrode catalyst layer is formed by depositing porous carbon particles uniformly on the surface of the first gas diffusion layer, and platinum alloy is supported on surfaces of the carbon particles.

The anode 36 includes a second electrode catalyst layer joined to the other surface 32b of the electrolyte membrane 32, and a second gas diffusion layer stacked on the second electrode catalyst layer. The second electrode catalyst layer is formed by depositing porous carbon particles uniformly on the surface of the second gas diffusion layer, and platinum alloy is supported on surfaces of the carbon particles. Each of the first gas diffusion layer and the second gas diffusion layer comprises a carbon paper, a carbon cloth, etc.

The surface size of the electrolyte membrane 32 is smaller than the surface size of the cathode 34 and the anode 36. The outer marginal portion of the cathode 34 and the outer marginal portion of the anode 36 hold the inner marginal portion of the resin frame member 30. The resin frame member 30 has non-impermeable structure where the reactant gases (the oxygen-containing gas and the fuel gas) do not pass through the resin frame member 30. The resin frame member 30 is provided on the outer peripheral side of the MEA 28.

The resin frame equipped MEA 16 may not use the resin frame member 30, and may use the electrolyte membrane 32 which protrudes outward. Further, the resin frame equipped MEA 16 may be formed by providing frame shaped films on both sides of the electrolyte membrane 32.

In FIG. 1, each of the first metal separator 18 and the second metal separator 20 has a rectangular shape (quadrangular shape). Each of the first metal separator 18 and the second metal separator 20 is formed by press forming of an iron plate such as a steel plate, a stainless steel plate, a plated steel plate, or an aluminum plate, a titanium plate, or a steel thin plate (e.g., plate having the thickness in the range of not less than 75 μm and not more than 150 μm) having an anti-corrosive surface by surface treatment, to have a corrugated shape in cross section and a wavy shape on the surface. In the state where the first metal separator 18 and the second metal separator 20 are overlapped with each other, outer peripheral portions of the first metal separator 18 and the second metal separator 20 are joined together by welding, brazing, crimping, etc. integrally to form a joint separator 11.

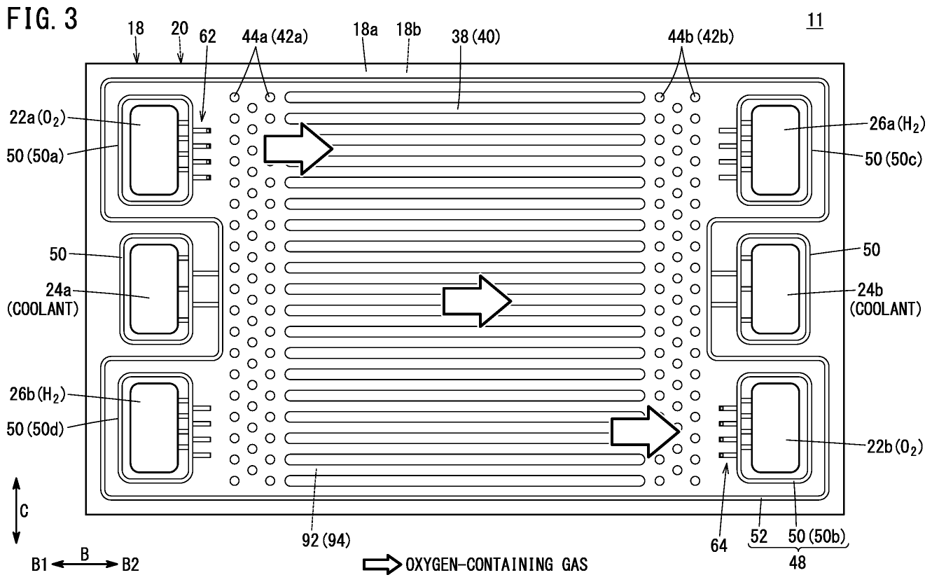

As shown in FIGS. 2 and 3, the first metal separator 18 has an oxygen-containing gas flow field 38 on its surface (hereinafter referred to as a “surface 18a”) facing the MEA 28. The oxygen-containing gas flow field 38 is connected to the oxygen-containing gas supply passage 22a and the oxygen-containing gas discharge passage 22b. The oxygen-containing gas flow field 38 includes a plurality of oxygen-containing gas flow grooves 40 extending straight in the direction indicated by the arrow B. Each of the oxygen-containing gas flow grooves 40 may extend in a wavy pattern in the direction indicated by the arrow B.

In FIG. 3, a first inlet buffer 44a is provided on the surface 18a of the first metal separator 18, between the oxygen-containing gas supply passage 22a and the oxygen-containing gas flow field 38. The first inlet buffer 44a includes a plurality of bosses 42a. Further, a first outlet buffer 44b is provided on the surface 18a of the first metal separator 18, between the oxygen-containing gas discharge passage 22b and the oxygen-containing gas flow field 38. The first outlet buffer 44b includes a plurality of bosses 42b.

The first metal separator 18 is provided with a first seal 48 for preventing leakage of fluid, i.e., the reactant gases (the oxygen-containing gas such as the air and the fuel gas such as hydrogen) and the coolant. The first seal 48 extends straight as viewed in the separator thickness direction (indicated by the arrow A). It should be noted that the first seal 48 may extend in a wavy pattern as viewed in the separator thickness direction.

The first seal 48 includes a plurality of first passage seals 50 surrounding a plurality of fluid passages (oxygen-containing gas supply passage 22a, etc.), respectively, and a first outer seal 52. The plurality of first passage seals 50 are provided around the oxygen-containing gas supply passage 22a, the oxygen-containing gas discharge passage 22b, the coolant supply passage 24a, the coolant discharge passage 24b, the fuel gas supply passage 26a, and the fuel gas discharge passage 26b, respectively.

Hereinafter, among the plurality of first passage seals 50, the first passage seal provided around the oxygen-containing gas supply passage 22a will be referred to as a “first passage seal 50a”, and the first passage seal provided around the oxygen-containing gas discharge passage 22b will be referred to as a “first passage seal 50b”. Further, among the plurality of first passage seals 50, the first passage seal provided around the fuel gas supply passage 26a will be referred to as a “first passage seal 50c”, and the first passage seal provided around the fuel gas discharge passage 26b will be referred to as a “first passage seal 50d”. The first outer seal 52 is provided around the oxygen-containing gas flow field 38, the first inlet buffer 44a, the first outlet buffer 44b, and the plurality of first passage seals 50a to 50d.

In FIG. 2, the first seal 48 includes a first metal bead 54 and a first resin member 56 provided on the first metal bead 54. The first metal bead 54 is formed integrally with the first metal separator 18, and protrudes in a direction away from the second metal separator 20. The first metal bead 54 protrudes from the first metal separator 18 toward the resin frame member 30. The lateral cross-sectional shape of the first metal bead 54 is a trapezoidal shape which is tapered in a protruding direction in which the first metal bead 54 protrudes.

The first metal bead 54 includes a pair of first bead side portions 58 disposed to face each other, and a first bead top portion 60 coupling the protruding ends of the pair of first bead side portions 58. The distance between the pair of first bead side portions 58 gradually becomes smaller toward the first bead top portion 60. In the state where the compression load is applied to the joint separator 11, the protruding end surface of the first metal bead 54 has a flat shape.

The first resin member 56 is an elastic member fixed to the protruding end surface of the first metal bead 54 by printing, coating, etc. For example, the first resin member 56 is made of polyester fiber.

As shown in FIG. 3, in the first metal separator 18, a bridge section 62 connecting the inside (side closer to the oxygen-containing gas supply passage 22a) and the outside (side closer to the oxygen-containing gas flow field 38) of the first passage seal 50a is provided. Further, in the first metal separator 18, a bridge section 64 connecting the inside (side closer to the oxygen-containing gas discharge passage 22b) and the outside (side closer to the oxygen-containing gas flow field 38) of the first passage seal 50b is provided.

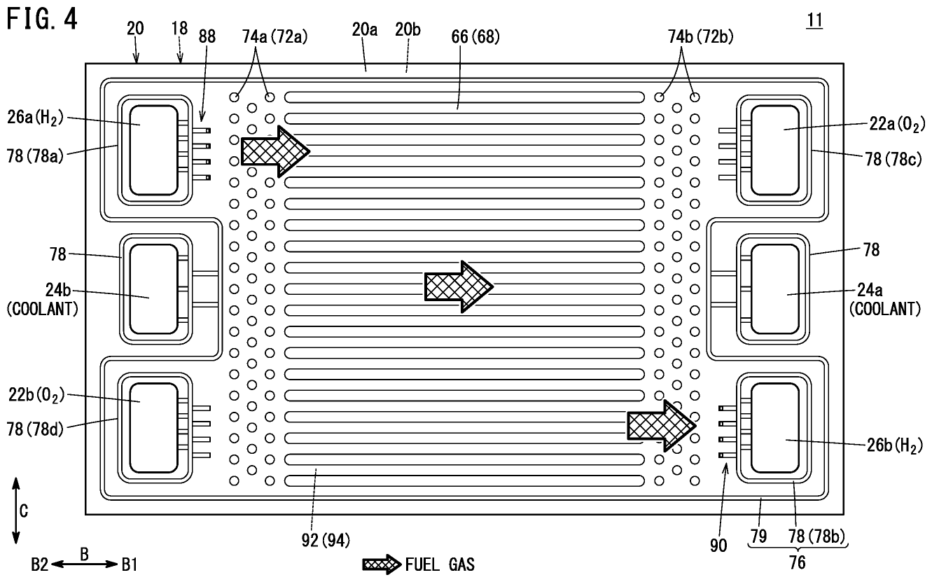

As shown in FIGS. 2 and 4, the second metal separator 20 has a fuel gas flow field 66 on its surface facing the MEA 28 (hereinafter referred to as a “surface 20a”). The fuel gas flow field 66 is connected to the fuel gas supply passage 26a and the fuel gas discharge passage 26b. The fuel gas flow field 66 includes a plurality of fuel gas flow grooves 68 extending in the direction indicated by the arrow B. Each of the fuel gas flow grooves 68 may extend in the direction indicated by the arrow B in a wavy pattern.

In FIG. 4, a second inlet buffer 74a is provided on the surface 20a of the second metal separator 20, between the fuel gas supply passage 26a and the fuel gas flow field 66. The second inlet buffer 74a includes a plurality of bosses 72a. Further, a second outlet buffer 74b is provided on the surface 20a of the second metal separator 20, between the fuel gas discharge passage 26b and the fuel gas flow field 66. The second outlet buffer 74b includes a plurality of bosses 72b.

The second metal separator 20 is provided with a second seal 76 for preventing leakage of fluid, i.e., the reactant gases (the oxygen-containing gas and the fuel gas) and the coolant. The second seal 76 extends straight as viewed in the separator thickness direction (indicated by the arrow A). It should be noted that the second seal 76 may extend in a wavy pattern as viewed in the separator thickness direction.

The second seal 76 includes a plurality of second passage seals 78 provided around the plurality of fluid passages (oxygen-containing gas supply passage 22a, etc.), respectively, and a second outer seal 79. The plurality of second passage seals 78 are provided around the oxygen-containing gas supply passage 22a, the oxygen-containing gas discharge passage 22b, the coolant supply passage 24a, the coolant discharge passage 24b, the fuel gas supply passage 26a, and the fuel gas discharge passage 26b, respectively.

Hereinafter, among the plurality of second passage seals 78, the second passage seal provided around the fuel gas supply passage 26a will be referred to as a “second passage seal 78a”, and the second passage seal provided around the fuel gas discharge passage 26b will be referred to as a “second passage seal 78b”. Further, among the plurality of second passage seals 78, the second passage seal provided around the oxygen-containing gas supply passage 22a will be referred to as a “second passage seal 78c”, and the second passage seal provided around the oxygen-containing gas discharge passage 22b will be referred to as a “second passage seal 78d”. The second outer seal 79 is provided around the oxygen-containing gas flow field 38, the second inlet buffer 74a, the second outlet buffer 74b, and the plurality of second passage seals 78a to 78d.

In FIG. 2, the second seal 76 includes a second metal bead 80 and a second resin member 82 provided on the second metal bead 80. The second metal bead 80 is formed integrally with the second metal separator 20, and protrudes in a direction away from the first metal separator 18. The second metal bead 80 protrudes from the second metal separator 20 toward the resin frame member 30. The lateral cross-sectional shape of the second metal bead 80 is a trapezoidal shape which is tapered in the protruding direction in which the second metal bead 80 protrudes.

The second metal bead 80 includes a pair of second bead side portions 84 disposed to face each other, and a second bead top portion 86 coupling the protruding ends of the pair of second bead side portions 84. The distance between the pair of second bead side portions 84 gradually becomes smaller toward the second bead top portion 86. In the state where the compression load is applied to the joint separator 11, the protruding end surface of the second metal bead 80 has a flat shape.

The second resin member 82 is an elastic member fixed to the protruding end surface of the second metal bead 80 by printing or coating. For example, the second resin member 82 is made of polyester fiber.

The first seal 48 and the second seal 76 are disposed so as to be overlapped with each other as viewed in the separator thickness direction. Therefore, in the state where the compression load is applied to the stack body 14, each of the first metal bead 54 and the second metal bead 80 is deformed elastically (deformed by compression). Further, in this state, a protruding end surface 48a of the first seal 48 (first resin member 56) contacts one surface 30a of the resin frame member 30 in an air tight and liquid tight manner, and a protruding end surface 76a of the second seal 76 (second resin member 82) contacts the other surface 30b of the resin frame member 30 in an air tight and liquid tight manner.

The first resin member 56 may be provided on one surface 30a of the resin frame member 30 instead of the first metal bead 54. The second resin member 82 may be provided on the other surface 30b of the resin frame member 30 instead of the second metal bead 80. Further, at least one of the first resin member 56 and the second resin member 82 may be dispensed with.

As shown in FIG. 4, in the second metal separator 20, a bridge section 88 connecting the inside (side closer to the fuel gas supply passage 26a) and the outside (side closer to the fuel gas flow field 66) of the second passage seal 78a is provided. Further, in the second metal separator 20, a bridge section 90 connecting the inside (side close to the fuel gas discharge passage 26b) and the outside (side closer to the fuel gas flow field 66) of the second passage seal 78b is provided.

In FIGS. 1 and 2, a coolant flow field 92 is provided between a surface 18b of the first metal separator 18 and a surface 20b of the second metal separator 20. The coolant flow field 92 is connected to the coolant supply passage 24a and the coolant discharge passage 24b. The coolant flow field 92 includes a plurality of coolant flow grooves 94 extending straight in the direction indicated by the arrow B. The coolant flow field 92 is formed by the back surface of the oxygen-containing gas flow field 38 and the back surface of the fuel gas flow field 66.

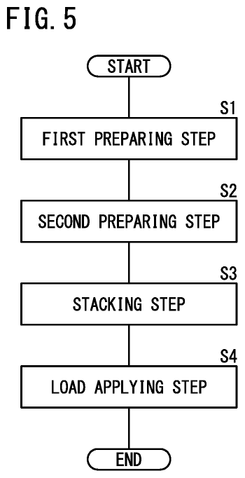

Next, a method of producing the fuel cell stack 10 will be described. As shown in FIG. 5, the method of producing the fuel cell stack 10 includes a first preparing step, a second preparing step, a stacking step, and a load applying step.

In the first preparing step (step S1), an electrolyte membrane 32 is prepared. Then, catalyst paste (solution containing a catalyst and components of the electrolyte membrane 32) is coated on both sides of the electrolyte membrane 32, and hot pressing is performed thereon. As a result, the cathode 34 and the anode 36 are provided on both sides of the electrolyte membrane 32 to produce the resin frame equipped MEA 16.

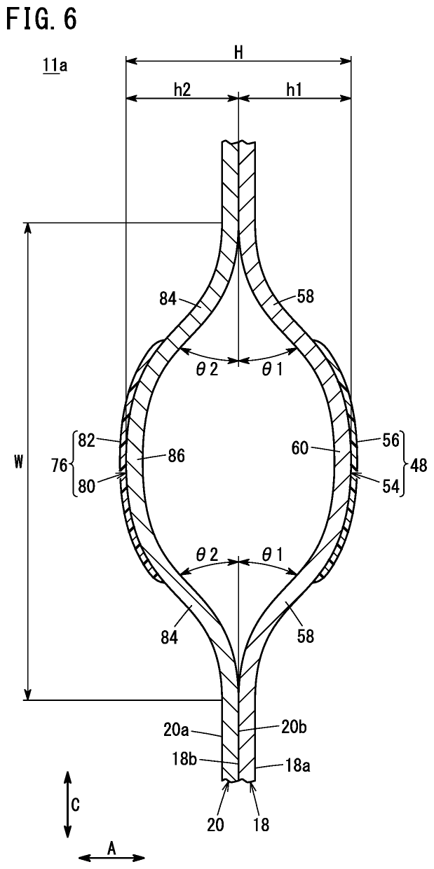

In the second preparing step (step S2), in the state where the first metal separator 18 and the second metal separator 20 are stacked together, the first metal separator 18 and the second metal separator 20 are joined together to prepare a joint separator 11a (see FIG. 6). It should be noted that the joint separator 11a is the joint separator 11 before the compression load is applied.

Specifically, in the second preparing step, as shown in FIG. 6, the first metal bead 54 as a seal extending in a line pattern is formed integrally with the first metal separator 18 (by press forming), so as to protrude in a direction away from the second metal separator 20. In the joint separator 11a, the lateral cross-sectional shape of the first bead top portion 60 is curved in a circular arc shape in a manner to protrude in a direction away from the second metal separator 20.

Further, in the second preparing step, the second metal bead 80 as a seal extending in a line pattern is formed integrally with the second metal separator 20 (by press forming), so as to protrude in a direction away from the first metal separator 18. In the joint separator 11a, the first metal bead 54 and the second metal bead 80 are disposed so as to be overlapped with each other as viewed in the separator thickness direction. In the joint separator 11a, the second bead top portion 86 is curved in a circular arc shape in a manner to protrude in a direction away from the first metal separator 18.

In the joint separator 11a, a protruding height h1 of the first metal bead 54 from the first metal separator 18 is the same as a protruding height h2 of the second metal bead 80 from the second metal separator 20. In this regard, the protruding height h1 herein means the distance from the root of the first metal bead 54 to the protruding end of the first metal bead 54. The protruding height h2 herein means the distance from the root of the second metal bead 80 to the protruding end of the second metal bead 80.

That is, in the joint separator 11a, a bead height H as the distance between the protruding end of the first metal bead 54 and the protruding end of the second metal bead 80 is the sum of the protruding height h1 and the protruding height h2. The first metal bead 54 and the second metal bead 80 have the same bead width W. The bead width W herein means the width of the root where the first metal bead 54 (second metal bead 80) starts to protrude.

A bead width ratio (W/H) which is the ratio of the bead width (W) to the bead height (H) is set to be in the range of not less than 2.25 and not more than 3.35. Stated otherwise, in the joint separator 11a, the ratio of the bead width W to the protruding height h1 (protruding height h2) is set to be in the range of not less than 4.5 and not more than 6.7.

In the stacking step (step S3), the resin frame equipped MEAs 16 prepared in the first preparing step and the joint separators 11a prepared in the second preparing step are stacked together alternately.

In the load applying step (step S4), after the stacking step, the compression load in the separator thickness direction is applied to the resin frame equipped MEA 16 and the joint separator 11a. Then, as shown in FIG. 2, each of the first metal bead 54 and the second metal bead 80 is deformed elastically, and the joint separator 11a becomes the joint separator 11. As a result, a desired seal surface pressure is applied to each of the protruding end surface 48a of the first seal 48 and the protruding end surface 76a of the second seal 76. After completion of the load applying step, the fuel cell stack 10 is produced.

Next, setting of the bead dimension ratio will be described further in detail. As shown in FIG. 6, as the bead dimension ratio becomes small, an inclination angle θ1 at which the first bead side portion 58 is inclined from the surface 18b of the first metal separator 18 (the surface which contacts the second metal separator 20) becomes large. It should be noted that the first bead side portions 58 on both sides are inclined at the same inclination angel θ1. Further, as the bead dimension ratio becomes small, an inclination angle θ2 at which the second bead side portion 84 is inclined from the surface 20b of the second metal separator 20 (the surface which contacts the first metal separator 18) becomes large. It should be noted that the second bead side portions 84 on both sides are inclined at the same inclination angle θ2.

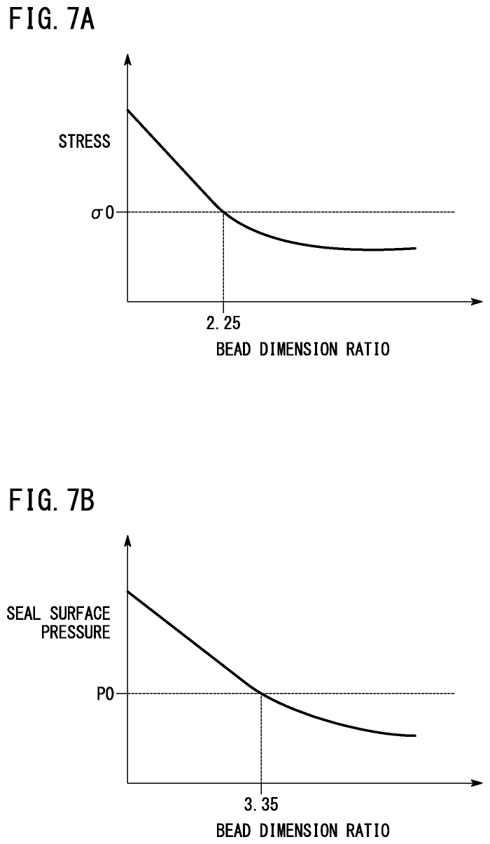

FIG. 7A is a graph showing the relationship between the bead dimension ratio and the stress. In this regard, the stress herein means a stress applied to the first bead top portion 60 (second bead top portion 86) when the compression stress is applied to the joint separator 11a. As the bead dimension ratio becomes small, the spring constant of the first bead side portion 58 and the spring constant of the second bead side portion 84 become large (the inclination angles θ1, θ2 become large). Therefore, as shown in FIG. 7A, the stress applied to each of the first bead top portion 60 and the second bead top portion 86 when the compression load is applied to the joint separator 11a (when the compression load is applied to the stack body 14) becomes large as the bead dimension ratio becomes small.

Further, in the case where the bead dimension ratio becomes less than 2.25, the stress applied to each of the first bead top portion 60 and the second bead top portion 86 when the compression load is applied to the joint separator 11a becomes a buckling stress σ0 or more. The buckling stress σ0 herein means a stress where, when the compression load is applied to the joint separator 11a, at least one of the first bead top portion 60 and the second bead top portion 86 is buckled, and deformed to have a recessed shape. Therefore, the lower limit value of the bead dimension ratio is set to 2.25.

FIG. 7B is a graph showing the relationship between the bead dimension ratio and the seal surface pressure. As the bead dimension ratio becomes large, the spring constant of the first bead side portion 58 and the spring constant of the second bead side portion 84 become small (inclination angles θ1, θ2 become small). Therefore, as shown in FIG. 7B, the seal surface pressure applied to each of the first bead top portion 60 and the second bead top portion 86 when the compression load is applied to the joint separator 11a becomes small as the bead dimension ratio becomes large.

Further, in the case where bead dimension ratio becomes larger than 3.35, the seal surface pressure applied to each of the first bead top portion 60 and the second bead top portion 86 when the compression load is applied to the joint separator 11a becomes a minimum seal surface pressure P0 or less. In this regard, the minimum seal surface pressure P0 herein means a pressure where, when the compression load is applied to the joint separator 11a, leakage of the fluid (reactant gases and the coolant) occurs from at least one of a portion between the first seal 48 and the resin frame member 30 and a portion between the second seal 76 and the resin frame member 30. Therefore, the upper limit value of the bead dimension ratio is set to 3.35.

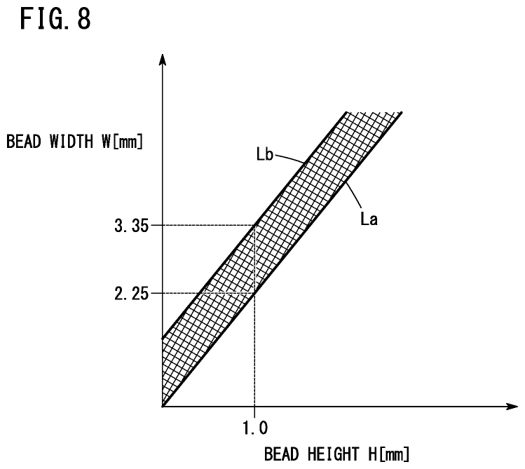

That is, as shown in FIG. 8, the bead width W and the bead height H are set within a range between a lower limit value line La and an upper limit value line Lb of the bead dimension ratio. Specifically, for example, in the case where the bead height H is set to 1.0 mm, the bead width W is set to be within the range of not less than 2.25 mm and not more than 3.35 mm. Stated otherwise, in the joint separator 11a, the ratio of the bead width W to the protruding height h1 (protruding height h2) is set to be in the range of not less than 4.5 and not more than 6.7.

Next, operation of the fuel cell stack 10 having the structure will be described.

Firstly, as shown in FIG. 1, the oxygen-containing gas is supplied to the oxygen-containing gas supply passage 22a. The fuel gas is supplied to the fuel gas supply passage 26a. The coolant is supplied to the coolant supply passage 24a.

The oxygen-containing gas is supplied from the oxygen-containing gas supply passage 22a into the oxygen-containing gas flow field 38 of the first metal separator 18. The oxygen-containing gas flows along the oxygen-containing gas flow field 38 in the direction indicated by the arrow B, and the oxygen-containing gas is supplied to the cathode 34 of the MEA 28.

In the meanwhile, the fuel gas is supplied from the fuel gas supply passage 26a into the fuel gas flow field 66 of the second metal separator 20. The fuel gas flows into the fuel gas flow field 66 in the direction indicated by the arrow B, and the fuel gas is supplied to the anode 36 of the MEA 28.

Therefore, in each of the MEA 28, the oxygen-containing gas supplied to the cathode 34 and the fuel gas supplied to the anode 36 are partially consumed in electrochemical reactions to perform power generation.

Then, the oxygen-containing gas supplied to the cathode 34 is partially consumed at the cathode 34, and the oxygen-containing gas is discharged along the oxygen-containing gas discharge passage 22b in the direction indicated by the arrow A. Likewise, the fuel gas supplied to the anode 36 is partially consumed at the anode 36, and the fuel gas is discharged along the fuel gas discharge passage 26b in the direction indicated by the arrow A.

Further, the coolant supplied to the coolant supply passage 24a flows into the coolant flow field 92 formed between the first metal separator 18 and the second metal separator 20, and then, flows in the direction indicated by the arrow B. After the coolant cools the MEA 28, the coolant is discharged from the coolant discharge passage 24b.

The present invention offers the following advantages.

The first metal bead 54 and the second metal bead 80 have the same bead width W. In the joint separator 11a, the ratio (first bead dimension ratio) of the bead width W to the bead height H is set to be within the range of not less than 2.25 and not more than 3.35 where the bead height is a distance between a protruding end of the first metal bead 54 and a protruding end of the second metal bead 80. Further, the ratio (second bead dimension ratio) of the bead width W to the protruding height h1 of the first metal bead 54 (protruding height h2 of the second metal bead 80) is set to be within the range of not less than 4.5 and not more than 6.7.

In the structure, since the bead dimension ratio is not less than 2.25 (since the ratio of the bead width W to the protruding height h1, h2 is not less than 4.5), the spring constant of each of the first bead side portion 58 and the second bead side portion 84 does not become excessively large. Therefore, when the compression load is applied to the joint separator 11a, it is possible to suppress buckling of the first bead top portion 60 and the second bead top portion 86. Further, since the bead dimension ratio is not more than 3.35 (since the ratio of the bead width W to the protruding height h1, h2 is not more than 6.7), the spring constant of each of the first bead side portion 58 and the second bead side portion 84 does not become excessively small. Therefore, when the compression load is applied to the joint separator 11a, it is possible to apply the desired seal surface pressure to the first bead top portion 60 and the second bead top portion 86.

In the joint separator 11a, the lateral cross-sectional shape of the first bead top portion 60 of the first metal bead 54 and the lateral cross-sectional shape of the second bead top portion 86 of the second metal bead 80 are curved in a circular arc shape.

In the structure, when the compression load is applied to the joint separator 11a, it is possible to efficiently increase the seal surface pressure applied to the first bead top portion 60 and the second bead top portion 86.

The protruding height h1 of the first metal bead 54 from the first metal separator 18 and the protruding height h2 of the second metal bead 80 from the second metal separator 20 are the same.

In the structure, it is possible to elastically deform the first metal bead 54 and the second metal bead 80 with good balance. Therefore, it is possible to suppress variation in the seal surface pressure applied to the first seal 48 and the seal surface pressure applied to the second seal 76.

The present invention is not limited to the above described embodiment. Various modifications can be made without departing from the gist of the present invention.

The above embodiment can be summarized as follows:

The above embodiment discloses the joint separator (11a) to be incorporated into the fuel cell stack (10), wherein the joint separator is formed by joining the first metal separator (18) and the second metal separator (20) together in the state where the first metal separator and the second metal separator are stacked together, the joint separator being applied with a compression load in a separator thickness direction when the joint separator is incorporated in the fuel cell stack. The first metal bead (54) as a seal is formed in the first metal separator. The first metal bead is elastically deformable by the compression load. The first metal bead extends in a line pattern. The first metal bead is formed integrally with the first metal separator, and protrudes in a direction away from the second metal separator. The second metal bead (80) as a seal is formed in the second metal separator. The second metal bead is elastically deformable by the compression load. The second metal bead extends in a line pattern. The second metal bead is formed integrally with the second metal separator, and protrudes in a direction away from the first metal separator. The first metal bead and the second metal bead have the same bead width (W). The ratio (W/H) of the bead width to the bead height (H) is set to be within the range of not less than 2.25 and not more than 3.35, where the bead height is a distance between a protruding end of the first metal bead and a protruding end of the second metal bead.

In the above joint separator, the lateral cross-sectional shape of the top portion (60) of the first metal bead and the lateral cross-sectional shape of the top portion (86) of the second metal bead may be curved in a circular arc shape.

In the above joint separator, the protruding height (h1) of the first metal bead from the first metal separator and the protruding height (h2) of the second metal bead from the second metal separator may be the same.

In the above joint separator, the first metal bead and the second metal bead may be disposed so as to be overlapped with each other as viewed in the separator thickness direction.

In the above joint separator, the inclination angle (θ1) at which the side portion (58) of the first metal bead is inclined from the surface (18b) of the first metal separator that contacts the second metal separator may be the same as the inclination angle (θ2) at which the side portion (84) of the second metal bead is inclined from the surface (20b) of the second metal separator that contacts the first metal separator.

The above embodiment discloses the metal separator (18, 20) to be incorporated into the fuel cell stack. The metal separator is applied with a compression load in a separator thickness direction when the metal separator is incorporated in the fuel cell stack. The metal bead (54, 80) as a seal is formed in the metal separator. The metal bead is elastically deformable by the compression load. The metal bead extends in a line pattern. The metal bead is formed integrally with the metal separator, and protrudes in the separator thickness direction. The ratio of the bead width of the metal bead to the bead height is set to be within the range of not less than 4.5 and not more than 6.7, where the bead height is the protruding height of the metal bead.

The above embodiment discloses the method of producing the fuel cell stack. The method includes the first preparing step of preparing the membrane electrode assembly (16) including the electrolyte membrane (32) and the electrodes (34, 36) provided on both sides of the electrolyte membrane (32), the second preparing step of preparing the joint separator formed by joining the first metal separator and the second metal separator together in the state where the first metal separator and the second metal separator are stacked together, the stacking step of stacking the membrane electrode assembly and the joint separator together alternately, and the load applying step of, after the stacking step, applying a compression load in a separator thickness direction to the membrane electrode assembly and the joint separator. In the second preparing step, the first metal bead as a seal is formed in the first metal separator. The first metal bead is elastically deformable by the compression load. Further, the second metal bead as a seal is formed in the second metal separator. The second metal bead is elastically deformable by the compression load. The first metal bead extends in a line pattern. The first metal bead is formed integrally with the first metal separator, and protrudes in a direction away from the second metal separator. The second metal bead extends in a line pattern. The second metal bead is formed integrally with the second metal separator, and protrudes in a direction away from the first metal separator. The first metal bead and the second metal bead have the same bead width. The ratio of the bead width to the bead height is set to be within the range of not less than 2.25 and not more than 3.35, where the bead height is a distance between a protruding end of the first metal bead and a protruding end of the second metal bead.

What is claimed is:

1. A joint separator to be incorporated into a fuel cell stack, wherein:
the joint separator is formed by joining a first metal separator and a second metal separator together in a state where the first metal separator and the second metal separator are stacked together, the joint separator being applied with a compression load in a separator thickness direction when the joint separator is incorporated in the fuel cell stack;
a first metal bead as a seal is formed in the first metal separator, the first metal bead being elastically deformable by the compression load;
the first metal bead extends in a line pattern, the first metal bead being formed integrally with the first metal separator and protruding in a direction away from the second metal separator;
a second metal bead as a seal is formed in the second metal separator, the second metal bead being elastically deformable by the compression load;
the second metal bead extends in a line pattern, the second metal bead being formed integrally with the second metal separator and protruding in a direction away from the first metal separator;
the first metal bead and the second metal bead have a same bead width; and
a ratio of the bead width to a bead height is set to be within a range of not less than 2.25 and not more than 3.35, where the bead height is a distance between a protruding end of the first metal bead and a protruding end of the second metal bead.

2. The joint separator according to claim 1, wherein a lateral cross-sectional shape of a top portion of the first metal bead and a lateral cross-sectional shape of a top portion of the second metal bead are curved in a circular arc shape.

3. The joint separator according to claim 1, wherein a protruding height of the first metal bead from the first metal separator is identical to a protruding height of the second metal bead from the second metal separator.

4. The joint separator according to claim 1, wherein the first metal bead and the second metal bead are disposed so as to be overlapped with each other as viewed in the separator thickness direction.

5. The joint separator according to claim 1, wherein an inclination angle at which a side portion of the first metal bead is inclined from a surface of the first metal separator that contacts the second metal separator is identical to an inclination angle at which a side portion of the second metal bead is inclined from a surface of the second metal separator that contacts the first metal separator.

6. A metal separator to be incorporated into a fuel cell stack, wherein:
the metal separator is applied with a compression load in a separator thickness direction when the metal separator is incorporated in the fuel cell stack;
a metal bead as a seal is formed in the metal separator, the metal bead being elastically deformable by the compression load;
the metal bead extends in a line pattern, the metal bead being formed integrally with the metal separator and protruding in the separator thickness direction; and
a ratio of a bead width of the metal bead to a bead height is set to be within a range of not less than 4.5 and not more than 6.7, where the bead height is a protruding height of the metal bead.

7. A method of producing a fuel cell stack,
the method comprising:
a first preparing step of preparing a membrane electrode assembly, the membrane electrode assembly including an electrolyte membrane and electrodes provided on both sides of the electrolyte membrane;
a second preparing step of preparing a joint separator formed by joining a first metal separator and a second metal separator together in a state where the first metal separator and the second metal separator are stacked together;
a stacking step of stacking the membrane electrode assembly and the joint separator together alternately; and
a load applying step of, after the stacking step, applying a compression load in a separator thickness direction to the membrane electrode assembly and the joint separator, wherein:
in the second preparing step, a first metal bead as a seal is formed in the first metal separator, the first metal bead being elastically deformable by the compression load, and a second metal bead as a seal is formed in the second metal separator, the second metal bead being elastically deformable by the compression load;
the first metal bead extends in a line pattern, the first metal bead being formed integrally with the first metal separator and protruding in a direction away from the second metal separator;
the second metal bead extends in a line pattern, the second metal bead being formed integrally with the second metal separator and protruding in a direction away from the first metal separator;
the first metal bead and the second metal bead have a same bead width; and
a ratio of the bead width to a bead height is set to be within a range of not less than 2.25 and not more than 3.35, where the bead height is a distance between a protruding end of the first metal bead and a protruding end of the second metal bead.
